(19) United States
(12) Patent Application Publication
(10) Pub. No.: US 2007/0119648 A1
(43) Pub. Date: May 31, 2007

(54) Frame structure and structure for supporting automotive power unit

(75) Inventors: Tadashi Udo, Hiroshima (JP); Chun Nie, Hiroshima (JP)

Correspondence Address: NIXON PEABODY, LLP, 401 9TH STREET, NW, SUITE 900, WASHINGTON, DC, 20004-2128, US

(73) Assignee: DAIKYO NISHIKAWA CORPORATION, Hiroshima (JP)

(21) Appl. No.: 11/598,665

(22) Filed: Nov. 14, 2006

(30) Foreign Application Priority Data
Nov. 25, 2005 (JP) 2005-340039

(51) Int. Cl. B60K 17/16; B60K 17/24; B62D 21/00

(52) U.S. Cl. 180/379; 180/312; 180/378

(57) ABSTRACT

Generally triangular first and second longitudinal side portions are arranged in the lower half region of a longitudinal side member between the first and second flat members vertically spaced apart from each other and form projections and depressions longitudinally and alternately. Generally inverted triangular third and fourth longitudinal side portions are arranged in the upper half region between the first and second flat members and form projections and depressions longitudinally and alternately. The first longitudinal side portions are vertically opposed to the third longitudinal side portions such that the first and third longitudinal side portions form projections and depressions. The second longitudinal side portions are vertically opposed to the fourth longitudinal side portions such that the second and fourth longitudinal side portions form projections and depressions. The first through fourth longitudinal side portions are integrally coupled through associated rhombic connecting ribs located midway between the first and second flat members.

### CROSS-REFERENCE TO RELATED APPLICATIONS

The disclosure of Japanese Patent Application No. 2005-340039 filed Nov. 25, 2005 including specification, drawing and claims is incorporated herein by reference in its entirely.

### BACKGROUND OF THE INVENTION

(1) Field of the Invention

The present invention relates to frame structures and structures for supporting automotive power units using the frame structures.

(2) Description of Related Art

The following structure for supporting a power unit is disclosed in Japanese Unexamined Patent Publications Nos. 11-139169 and 2001-180294: In an automobile comprising a power unit composed of an automotive engine and a transmission, a differential unit and a propeller shaft through which the power unit and the differential unit are coupled to each other, a frame structure of U shape in cross section is juxtaposed with the propeller shaft so as to be coupled at one end to the power unit and at the other end to the differential unit. This enhances the torsional rigidity, flexural rigidity and other properties of the body of the automobile during traveling.

It is essential, for safety, to pursue research while making a strong effort to enhance the torsional rigidity, flexural rigidity and other properties of an automobile body during traveling as described above.

To cope with this, for example, it is considered to increase the thickness of such a frame structure as described above in order to enhance the rigidity of the frame structure itself. This, however, causes an increase in the weight of the frame structure. Furthermore, in a case where a frame structure is a molded product made of a resin, it is necessary to prevent an undercut from being produced in the molded product in order to permit removal of the molded product from an associated mold of a simple structure without using any slide mold. This automatically restricts the shape of the molded product. Consequently, the frame structure may be prevented from taking on an ideal high-rigidity structure. Nevertheless, in a case where a plurality of pieces into which a frame structure is divided are molded separately and then these pieces are assembled to form a single frame structure, this increases the number of process steps for fabricating the frame structure and the cost for molds. Therefore, this case is not practical.

### SUMMARY OF THE INVENTION

The present invention is made in view of the above-described problems, and its object is to provide a high-rigidity and lightweight frame structure and when the frame structure is a molded product made of a resin, facilitate molding the frame structure without expending unduly high cost.

In order to achieve the above-mentioned object, the present invention is characterized in that a frame structure is formed by appropriately assembling generally triangular side members and generally inverted triangular side members.

To be specific, the present invention is directed toward frame structures and structures for supporting automotive power units using the frame structures and provides the following solutions.

The inventions according to Claims 1 through 3 relate to a frame structure comprising first and second flat members having predetermined large widths and extending generally parallel to each other while being vertically spaced apart from each other. The first and second flat members are integrally coupled through a longitudinal side member to each other.

In the invention of Claim 1, the longitudinal side member includes: a plurality of first longitudinal side portions each having a generally triangular shape, partially forming parts of one of the faces of the longitudinal side member while being longitudinally spaced apart from one another, and each including a coupled part integrally coupled to associated one of the first and second flat members and a first extending part extending from said one of the faces of the longitudinal side member toward the other one of the faces of the longitudinal side member and located generally midway between the first and second flat members; a plurality of second longitudinal side portions each having a generally triangular shape, partially forming parts of the other one of the faces of the longitudinal side member so as to be recessed between adjacent ones of the first longitudinal side portions while being longitudinally spaced apart from one another, and each including a coupled part integrally coupled to said associated one of the first and second flat members and a second extending part extending from the other one of the faces of the longitudinal side member toward said one of the faces of the longitudinal side member and located generally midway between the first and second flat members; a plurality of third longitudinal side portions each having a generally inverted triangular shape, partially forming parts of the other one of the faces of the longitudinal side member so as to be recessed while being longitudinally spaced apart from one another, and each including a coupled part integrally coupled to the other one of the first and second flat members and opposed to the coupled part of associated one of the first longitudinal side portions and the first extending part; and a plurality of fourth longitudinal side portions each having a generally inverted triangular shape, partially forming parts of said one of the faces of the longitudinal side member between adjacent ones of the third longitudinal side portions while being longitudinally spaced apart from one another, and each including a coupled part integrally coupled to the other one of the first and second flat members and opposed to the couple part of associated one of the second longitudinal side portions and the second extending part. The first through fourth longitudinal side portions are integrally coupled through associated generally rhombic connecting ribs located generally midway between the first and second flat members while being longitudinally spaced apart from one another.

According to the invention of Claim 2, in the frame structure of Claim 1, the frame structure may be an injection-molded product, and a through hole may be formed along the thickness of the longitudinal side member to pass through each said connecting rib.

According to the invention of Claim 3, in the frame structure of Claim 1, the frame structure may be a product made of a resin and molded using a sheet molding compound, and the longitudinal side member may further include a plurality of middle longitudinal side portions located in substantially the middle of the thickness of the longitudinal side member and each formed inside and continuously with associated one of the connecting ribs.

The invention of Claim 4 relates to a structure for supporting, on an automobile body, an automotive power unit including an engine and a transmission by coupling the power unit and a differential unit through a propeller shaft. The frame structure of any one of Claims 1 through 3 is juxtaposed with the propeller shaft so as to be coupled at one end to the power unit and at the other end to the differential unit.

According to the invention of Claim 1, the first through fourth longitudinal side portions form parts of the longitudinal side member between the first and second flat members vertically spaced apart from each other and extending generally parallel to each other and are arranged in the following manner. The first and second longitudinal side portions each forming a generally triangular shape are longitudinally and alternately arranged closer to one of the first and second flat members than the other one thereof and form projections extending forward of the middle of the thickness of the longitudinal side member and depressions extending backward thereof, respectively. The third and fourth longitudinal side portions each forming a generally inverted triangular shape are longitudinally and alternately arranged closer to the other one of the first and second flat members than the above-described one thereof and form depressions extending backward of the middle of the thickness of the longitudinal side member and projections extending forward thereof, respectively. Furthermore, the first longitudinal side portions are vertically opposed to the third longitudinal side portions, and the first and third longitudinal side portions form projections extending forward of the middle of the thickness of the longitudinal side member and depressions extending backward thereof, respectively. The second longitudinal side portions are vertically opposed to the fourth longitudinal side portions, and the second and fourth longitudinal side portions form depressions extending backward of the middle of the thickness of the longitudinal side member and projections extending forward thereof, respectively. Moreover, each of the first longitudinal side portions, adjacent one of the second longitudinal side portions, adjacent one of the third longitudinal side portions, and adjacent one of fourth longitudinal side portions are integrally coupled generally midway between the first and second flat members through a generally rhombic connecting rib.

In view of the above, unlike a frame structure forming a simple U shape in cross section as disclosed in Japanese Unexamined Patent Publications Nos. 11-139169 and 2001-180294, the frame structure has the following three-dimensional structure. More specifically, large projections and depressions extending forward and backward of the middle of the thickness of the longitudinal side member are arranged longitudinally, alternately and successively, and one of the projections and associated one of the depressions are vertically opposed to each other. For example, when a depression is formed in the upper part of the frame structure, a projection is formed in the lower part thereof so as to be opposed to the depression. Thus, even when the frame structure is to be bent or to be twisted, the resistance of the plurality of projections and depressions to flexural stress and torsional stress further enhances the torsional rigidity, flexural rigidity and other properties of the frame structure, resulting in an increase in the rigidity thereof. Furthermore, since the thickness of the frame structure is not increased to ensure the rigidity thereof, the frame structure can be reduced in weight.

In particular, even when the frame structure is a molded product made of a resin, since the first through fourth longitudinal side portions are orthogonal to the thickness of the longitudinal side member and the connecting ribs are along the thickness thereof, this prevents an undercut from being produced in the molded frame structure and thus permits removal of the frame structure from an associated mold without using a mold having a complicated structure. As a result, a frame structure having an intended rigid structure can be formed. Moreover, the frame structure need not be formed by assembling a plurality of pieces. Therefore, a frame structure can be easily formed using a single mold without expending unduly high cost.

According to the invention of Claim 2, since the frame structure is an injection molded product and the cavity defined by a mold is sealed to withstand the pressure at which the cavity is filled, flash is not formed around the through hole in molding even with the through hole passing through the connecting rib. This eliminates the need for deflashing. In view of the above, as compared with a case where the middle longitudinal side portion is formed inside the connecting rib, a reduction in the weight of the frame structure can be further facilitated and the material cost can be reduced.

According to the invention of Claim 3, when the frame structure is a molded product made of a resin and molded using sheet molding compound (hereinafter, referred to as “SMC”), a resin material is pressed during molding so as to be spread out. Therefore, the formation of the through hole through the connecting rib causes flash to be formed between halves of a mold in molding. This provides the need for deflashing for removing flash from a molded product. However, since the middle longitudinal side portion is formed inside the connecting rib, this prevents flash from being formed on part of a molded product corresponding to the inside of the connecting rib in molding. This can eliminate the need for deflashing.

According to the invention of Claim 4, when the frame structure producing the effects as in Claims 1 through 3 is juxtaposed with the propeller shaft, this can further enhance the torsional rigidity, flexural rigidity, and other properties of an automobile body during traveling.

### BRIEF DESCRIPTION OF THE DRAWINGS

FIG. 1 is a front view of a frame structure.

FIG. 2 is a perspective view of the frame structure.

FIG. 3 is a cross-sectional view taken along the line A-A in FIGS. 1 and 2.

FIG. 4 is a cross-sectional view taken along the line B-B in FIGS. 1 and 2.

FIG. 5 is a cross-sectional view taken along the line C-C in FIGS. 1 and 2.

FIG. 6 is a cross-sectional view taken along the line D-D in FIGS. 1 and 2.

FIG. 7 is a plan view of FIG. 8.

FIG. 8 is a left side view of an automobile illustrating a structure for supporting a power unit.

### DETAILED DESCRIPTION OF THE INVENTION

An embodiment of the present invention will now be described in detail with reference to the drawings.

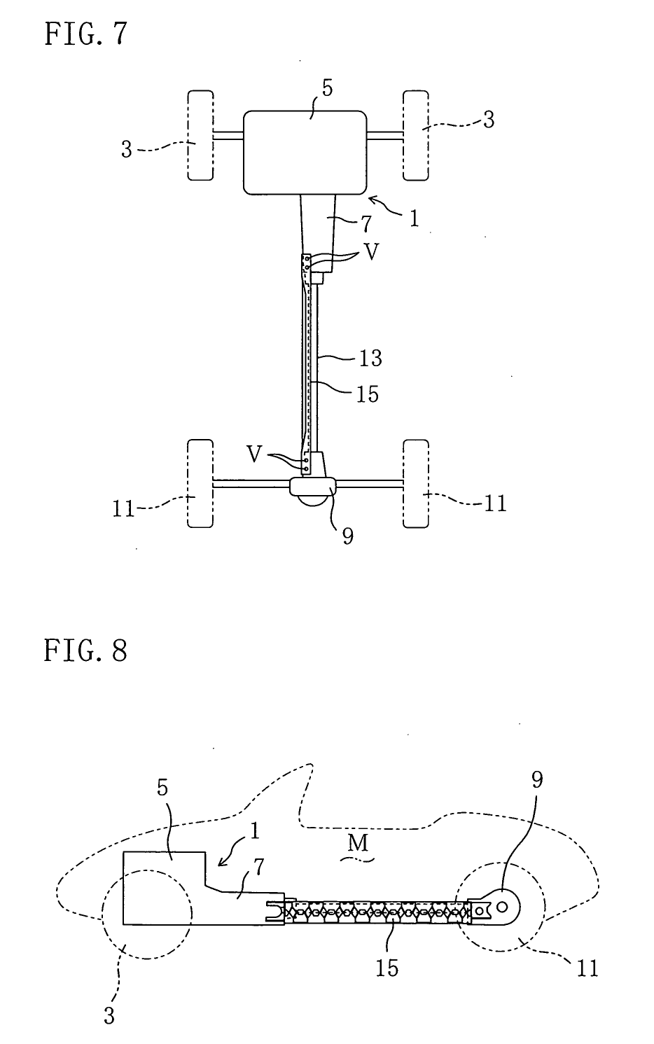

FIGS. 7 and 8 illustrate a structure for supporting a power unit of an automobile M according to the embodiment of the present invention. In FIGS. 7 and 8, reference numeral 1 denotes a power unit including an engine 5 and a transmission 7 both disposed near front wheels 3, and reference numeral 9 denotes a differential unit disposed near rear wheels 11. The transmission 7 and the differential unit 9 are coupled through a propeller shaft 13 to each other. The propeller shaft 13 is juxtaposed with a frame structure 15 that characterizes the present invention. The frame structure 15 is coupled at one end to the transmission 7 of the power unit 1 through associated bolts V and at the other end to the differential unit 9 through other associated bolts V.

The frame structure 15 is a molded product made of a resin and molded using SMC but not restrictive and may be an injection-molded product made of a resin. Alternatively, it may be made of a light-metal material, such as an aluminum alloy.

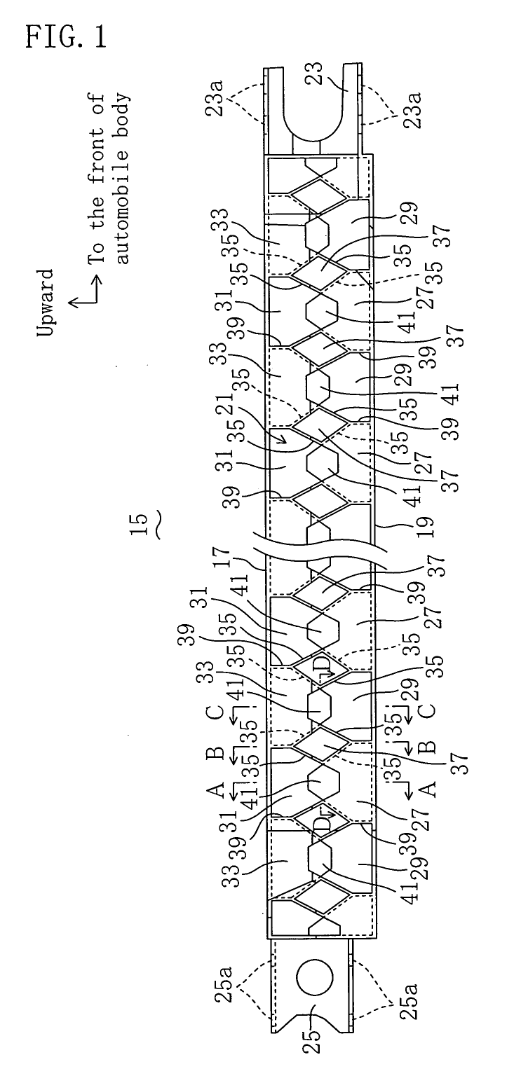

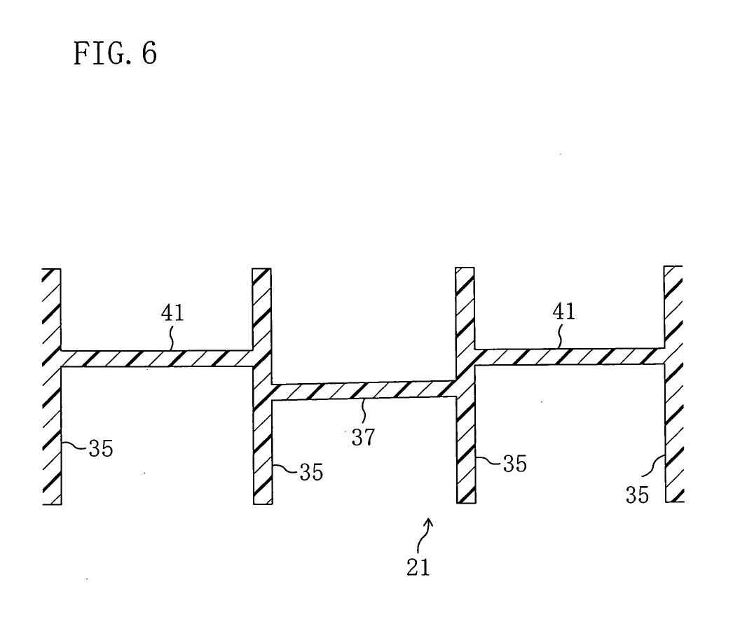

As illustrated in FIGS. 1 through 6, the frame structure 15 includes first and second flat members 17 and 19 having predetermined large widths. The lower second flat member 19 is wider than the upper first flat member 17. The first and second flat members 17 and 19 extend generally parallel to each other while being vertically spaced apart from each other and are vertically and integrally coupled through a longitudinal side member 21 to each other, thereby forming a frame structure 15. The frame structure 15 is provided at one end (near the front end of an automobile body) with a bracket 23 having mounting holes 23a and at the other end (near the rear end of the automobile body) with a bracket 25 having mounting holes 25a. The brackets 23 and 25 are formed continuously with the frame structure 15 to project from the frame structure 15. The bracket 23 is coupled to the transmission 7 by inserting and screwing the associated bolts V into the mounting holes 23a, and the bracket 25 is coupled to the differential unit 9 by inserting and screwing the other associated bolts V into the mounting holes 25a. The frame structure 15 is juxtaposed with the propeller shaft 13.

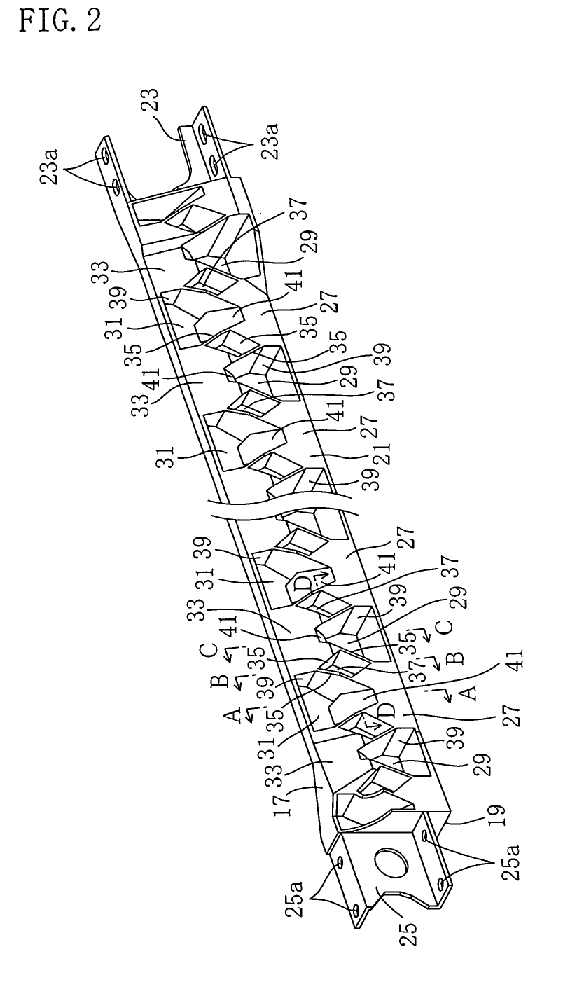

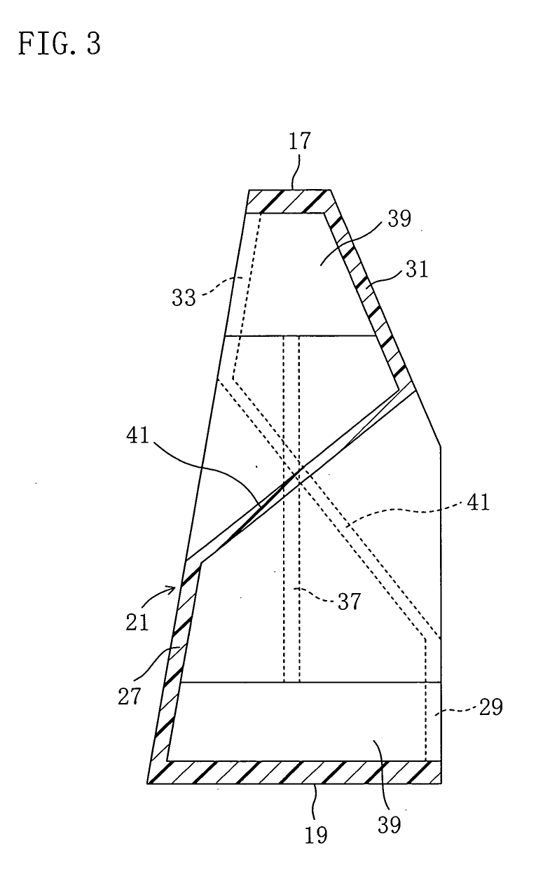

The longitudinal side member 21 includes a plurality of first longitudinal side portions 27, a plurality of second longitudinal side portions 29, a plurality of third longitudinal side portions 31, and a plurality of fourth longitudinal side portions 33. More specifically, the first longitudinal side portions 27 each having a generally triangular shape partially form parts of one of the faces of the longitudinal side member 21 (the front side of FIGS. 1 and 2 and the left side of FIGS. 3 through 5), are longitudinally spaced apart from one another and each include a coupled part (lower part) integrally coupled to one longitudinal edge of associated one of the first and second flat members 17 and 19, i.e., the second flat member 19, and a first extending part (upper part) extending from the above-described one of the faces of the longitudinal side member 21 toward the other one thereof and located generally midway between the first and second flat members 17 and 19 (see FIG. 3).

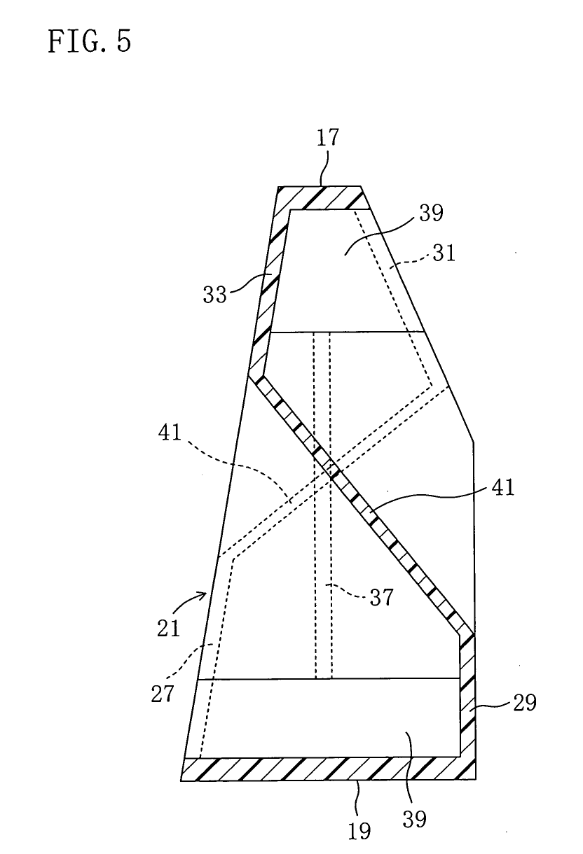

Like the first longitudinal side portions 27, the second longitudinal side portions 29 each having a generally triangular shape partially form parts of the other one of the faces of the longitudinal side member 21 (the rear side of FIGS. 1 and 2 and the right side of FIGS. 3 through 5), are configured so as to be recessed between adjacent ones of the first longitudinal side portions 27 while being longitudinally spaced apart from one another, and each include a coupled part (lower part) integrally coupled to the other longitudinal edge of the above-mentioned one of the first and second flat members 17 and 19, i.e., the second flat member 19, and a second extending part (upper part) extending from the above-described one of the faces of the longitudinal side member 21 toward the other one thereof and located generally midway between the first and second flat members 17 and 19 (see FIG. 5). In this way, the first and second longitudinal side portions 27 and 29 are arranged longitudinally and alternately and form projections extending forward of the middle of the thickness of the longitudinal side member 21 and depressions extending backward thereof, respectively, when viewed from FIG. 1.

The third longitudinal side portions 31 each having a generally inverted triangular shape unlike the first and second longitudinal side portions 27 and 29 partially form parts of the other one of the faces of the longitudinal side member 21 (the rear side of FIGS. 1 and 2 and the right side of FIGS. 3 through 5), are configured so as to be recessed while being longitudinally spaced apart from one another, and each include a coupled part (upper part) integrally coupled to one longitudinal edge of the other one of the first and second flat members 17 and 19, i.e., the first flat member 17, and opposed to the coupled part of associated one of the first longitudinal side portions 27 and the first extending part (lower part) (see FIG. 3). The third longitudinal side portions 31 are vertically opposed to the associated first longitudinal side portions 27.

The fourth longitudinal side portions 33 each having a generally inverted triangular shape like the third longitudinal side portions 31 partially form parts of the above-mentioned one of the faces of the longitudinal side member 21 (the front side of FIGS. 1 and 2 and the left side of FIGS. 3 through 5) between adjacent ones of the third longitudinal side portions 31 spaced apart from one another and each include a coupled part (upper part) integrally coupled to one longitudinal edge of the other one of the first and second flat members 17 and 19, i.e., the first flat member 17, and opposed to the coupled part of associated one of the second longitudinal side portions 29 and the second extending part (lower part). In the above-mentioned manner, the third and fourth longitudinal side portions 31 and 33 are arranged longitudinally and alternately and form depressions extending backward of the middle of the thickness of the longitudinal side member 21 and projections extending forward thereof, respectively, when viewed from FIG. 1. Furthermore, the first longitudinal side portions 27 are vertically opposed to the associated third longitudinal side portions 31, and the first and third longitudinal side portions 27 and 31 form projections extending forward of the middle of the thickness of the longitudinal side member 21 and depressions extending backward thereof, respectively, when viewed from FIG. 1. The second longitudinal side portions 29 are vertically opposed to the fourth longitudinal side portions 33, and the second and fourth longitudinal side portions 29 and 33 form depressions extending backward of the middle of the thickness of the longitudinal side member 21 and projections extending forward thereof, respectively, when viewed from FIG. 1.

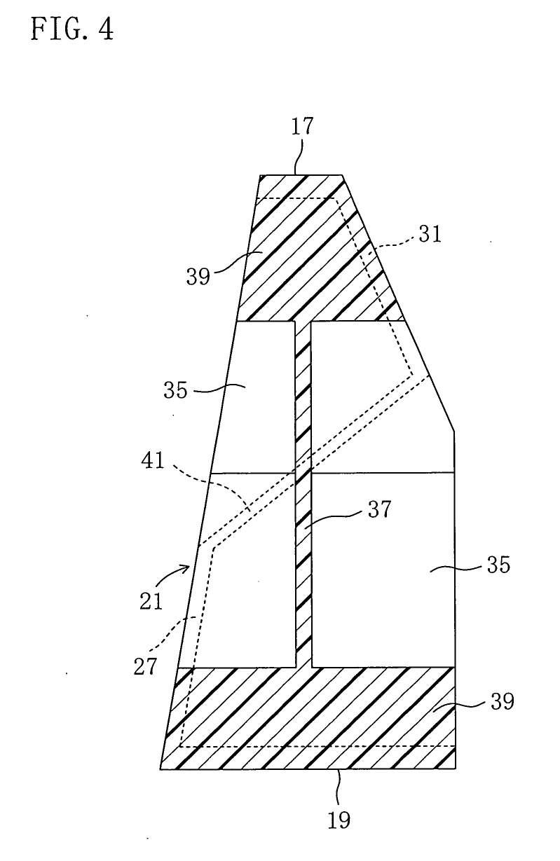

The first, second, third, and fourth longitudinal side portions 27, 29, 31, and 33 are integrally coupled through associated generally rhombic connecting ribs 35. The connecting ribs 35 are located generally midway between the first and second flat member 17 and 19 while being longitudinally spaced apart from one another and are orthogonal to the longitudinal direction of the longitudinal side member 21 (see FIG. 4). In other words, each connecting rib 35 is surrounded by associated one of the first longitudinal side portions 27, associated one of the second longitudinal side portions 29, associated one of the third longitudinal side portions 31, and associated one of the fourth longitudinal side portions 33. A middle longitudinal side portion 37 of the longitudinal side member 21 is formed inside and continuously with the connecting rib 35 so as to be located in the middle of the thickness of the longitudinal side member 21, i.e., in the middle of the width of the first or second flat member 17 or 19 (see FIG. 4).

Each first longitudinal side portion 27 and adjacent one of the second longitudinal side portions 29 are integrally coupled through a connecting rib 39 orthogonal to the longitudinal direction, and each third longitudinal side portion 31 and adjacent one of the fourth longitudinal side portions 33 are integrally coupled in the same way. Vertically opposed ones of the first and third longitudinal side portions 27 and 31 share a single associated inclined side portion 41 of the longitudinal side member 21, and vertically opposed ones of the second and fourth longitudinal side portions 29 and 33 share another single associated inclined side portion 41. In this manner, the inclined side portions 41 form the first extending parts of the first and third longitudinal side portions 27 and 31 and the second extending parts of the second and fourth longitudinal side portions 29 and 33.

In this example, as described above, a middle longitudinal side portion 37 is formed inside and continuously with each of connecting ribs 35. However, in a case where a frame structure 15 is an injection-molded product, a through hole may be formed, instead of the middle longitudinal side portion 37, along the thickness of the longitudinal side member 21 to pass through the connecting rib 35 (not shown). The reason for this is as follows. Since the frame structure 15 is an injection-molded product and the cavity defined by a mold is sealed to withstand the pressure at which the cavity is filled, flash is not formed around the through hole in molding even with the through hole passing through the connecting rib 35. This eliminates the need for deflashing. In view of the above, as compared with a case where the middle longitudinal side portion 37 is formed inside the connecting rib 35, a reduction in the weight of the frame structure can be further facilitated and the material cost can be reduced. The absence of the middle longitudinal side portion 37 hardly affects the rigidity of the frame structure 15. When a frame structure 15 is molded using SMC, a resin material is pressed during molding so as to be spread out. Therefore, the formation of the through hole through the connecting rib 35 causes flash to be formed between halves of a mold in molding. This provides the need for deflashing for removing the flash from the molded product. In view of the above, the middle longitudinal side portion 37 needs to be formed inside the connecting rib 35 to prevent flash from being formed in molding.

As described above, in this embodiment, the first, second, third, and fourth longitudinal side portions 27, 29, 31, and 33 form parts of the longitudinal side member 21 between the first and second flat members 17 and 19 vertically spaced apart from each other and extending generally parallel to each other and are arranged in the following manner. The first and second longitudinal side portions 27 and 29 each forming a generally triangular shape are longitudinally and alternately arranged closer to the second flat member 19 than the first flat member 17 and form projections extending forward of the middle of the thickness of the longitudinal side member 21 and depressions extending backward thereof, respectively, when viewed from FIG. 1. The third and fourth longitudinal side portions 31 and 33 each forming a generally inverted triangular shape are longitudinally and alternately arranged closer to the first flat member 17 than the second flat member 19 and form depressions extending backward of the middle of the thickness of the longitudinal side member 21 and projections extending forward thereof, respectively, when viewed from FIG. 1. Furthermore, the first longitudinal side portions 27 are vertically opposed to the third longitudinal side portions 31, and the first and third longitudinal side portions 27 and 31 form projections extending forward of the middle of the thickness of the longitudinal side member 21 and depressions extending backward thereof, respectively, when viewed from FIG. 1. The second longitudinal side portions 29 are vertically opposed to the fourth longitudinal side portions 33, and the second and fourth longitudinal side portions 29 and 33 form depressions extending backward of the middle of the thickness of the longitudinal side member 21 and projections extending forward thereof, respectively, when viewed from FIG. 1. Moreover, each of the first longitudinal side portions 27, adjacent one of the second longitudinal side portions 29, adjacent one of the third longitudinal side portions 31, and adjacent one of fourth longitudinal side portions 33 are integrally coupled generally midway between the first and second flat members 17 and 19 through a generally rhombic connecting rib 35.

In view of the above, unlike a frame structure forming a simple U shape in cross section as disclosed in Japanese Unexamined Patent Publications Nos. 11-139169 and 2001-180294, the frame structure 15 has the following three-dimensional structure. More specifically, large projections and depressions extending forward and backward of the middle of the thickness of the longitudinal side member 21 are arranged longitudinally, alternately and successively, and one of the projections and associated one of the depressions are vertically opposed to each other. For example, when a depression is formed in the upper part of the frame structure, a projection is formed in the lower part thereof so as to be opposed to the depression. Thus, even when the frame structure 15 is to be bent or to be twisted, the resistance of the plurality of projections and depressions to flexural stress and torsional stress further enhances the torsional rigidity, flexural rigidity and other properties of the frame structure 15, resulting in an increase in the rigidity thereof. Furthermore, since the thickness of the frame structure 15 is not increased to ensure the rigidity thereof, the frame structure 15 can be reduced in weight.

Furthermore, since the first, second, third, and fourth longitudinal side portions 27, 29, 31, and 33 are orthogonal to the thickness of the longitudinal side member 21 and the connecting ribs 35 and 39 are along the thickness thereof, this prevents an undercut from being formed in the molded frame structure 15 and thus permits removal of the frame structure 15 from a mold without using a mold having a complicated structure. As a result, a frame structure 15 having an intended rigid structure can be formed. Moreover, the frame structure 15 need not be formed by assembling a plurality of pieces. Therefore, a frame structure 15 can be easily formed using a single mold without expending unduly high cost.

When such a frame structure 15 is juxtaposed with a propeller shaft 13, this can further enhance the torsional rigidity, flexural rigidity, and other properties of an automobile body during traveling.

In this embodiment, the shape of each of the first and second longitudinal side portions 27 and 29 is represented as a generally triangular shape, and the shape of each of the third and fourth longitudinal side portions 31 and 33 is represented as a generally inverted triangular shape. However, the “generally triangular shape” and “generally inverted triangular shape” include shapes that are analogous to a trapezoidal shape or the like. The “generally rhombic shape” of each connecting rib 35 also includes analogous shapes.

In this embodiment, the first flat member 17 is formed to have a smaller width than the second flat member 19. However, this is not restrictive. The first flat member 17 may be formed to have the same width as the second flat member 19 or a larger width than the second flat member 19 according to applications of a frame structure 15.

Furthermore, in this embodiment, a frame structure 15 is applied to a structure for supporting a power unit of an automobile M. Alternatively, it can be applied to, for example, a frame for a side seat of the automobile M or other purposes than for the automobile M.

What is claimed is:

1. A frame structure comprising first and second flat members having predetermined large widths and extending generally parallel to each other while being vertically spaced apart from each other, the first and second flat members being integrally coupled through a longitudinal side member to each other,
the longitudinal side member comprising:
a plurality of first longitudinal side portions each having a generally triangular shape, partially forming parts of one of the faces of the longitudinal side member while being longitudinally spaced apart from one another, and each including a coupled part integrally coupled to associated one of the first and second flat members and a first extending part extending from said one of the faces of the longitudinal side member toward the other one of the faces of the longitudinal side member and located generally midway between the first and second flat members;
a plurality of second longitudinal side portions each having a generally triangular shape, partially forming parts of the other one of the faces of the longitudinal side member so as to be recessed between adjacent ones of the first longitudinal side members while being longitudinally spaced apart from one another, and each including a coupled part integrally coupled to said associated one of the first and second flat members and a second extending part extending from the other one of the faces of the longitudinal side member toward said one of the faces of the longitudinal side member and located generally midway between the first and second flat members;
a plurality of third longitudinal side portions each having a generally inverted triangular shape, partially forming parts of the other one of the faces of the longitudinal side member so as to be recessed while being longitudinally spaced apart from one another, and each including a coupled part integrally coupled to the other one of the first and second flat members and opposed to the coupled part of associated one of the first longitudinal side portions and the first extending part; and
a plurality of fourth longitudinal side portions each having a generally inverted triangular shape, partially forming parts of said one of the faces of the longitudinal side member between adjacent ones of the third longitudinal side portions while being longitudinally spaced apart from one another, and each including a coupled part integrally coupled to the other one of the first and second flat members and opposed to the couple part of associated one of the second longitudinal side portions and the second extending part,
the first through fourth longitudinal side portions being integrally coupled through associated generally rhombic connecting ribs, said connecting ribs being located generally midway between the first and second flat members while being longitudinally spaced apart from one another.

2. The frame structure of claim 1, wherein
the frame structure is an injection-molded product, and
a through hole is formed along the thickness of the longitudinal side member to pass through each said connecting rib.

3. The frame structure of claim 1, wherein
the frame structure is a product made of a resin and molded using a sheet molding compound, and
the longitudinal side member further includes a plurality of middle longitudinal side portions located in substantially the middle of the thickness of the longitudinal side member and each formed inside and continuously with associated one of the connecting ribs.

4. A structure for supporting, on an automobile body, an automotive power unit including an engine and a transmission by coupling the power unit and a differential unit through a propeller shaft,
the frame structure of any one of claims 1 through 3 is juxtaposed with the propeller shaft so as to be coupled at one end to the power unit and at the other end to the differential unit.
